(19) United States
(12) Patent Application Publication
(10) Pub. No.: US 2005/0202391 A1
(43) Pub. Date: Sep. 15, 2005

(54) EDUCATIONAL COURSE CONTENT DUPLICATOR AND MANAGER

(76) Inventors: J. Vance Allen, Denver, CO (US); Brian Burson, Highlands Ranch, CO (US); Scott Lewis, Littleton, CO (US); Eric Anderson, Denver, CO (US); Christa Hall, Highlands Ranch, CO (US)

Correspondence Address: SNELL & WILMER;ONE ARIZONA CENTER, 400 EAST VAN BUREN, PHOENIX, AZ, 850040001, US

(21) Appl. No.: 10/906,025

(22) Filed: Jan. 31, 2005

Related U.S. Application Data
(60) Provisional application No. 60/540,814, filed on Jan. 30, 2004.

(51) Int. Cl. G09B 7/00

(52) U.S. Cl. 434/362

(57) ABSTRACT

The invention provides for duplication of educational course content and associated files, data, and settings. The content duplication systems provides for prioritization of duplication requests, duplication status monitoring, renumbering of duplicated content items, automatic linking of duplicated content to source content, and duplication reporting.

### CROSS-REFERENCE TO RELATED APPLICATION

This application claims benefit from and priority to U.S. Provisional Patent Application Ser. No. 60/540,814, filed Jan. 30, 2004, which is hereby incorporated by reference in its entirety.

### FIELD OF INVENTION

The invention generally relates to systems and methods for duplicating and managing online educational courses and course content.

### BACKGROUND OF INVENTION

As the number of accredited online educational institutions and online courses offered by established institutions increases, administrators and educators are demanding more efficient and convenient course and content management tools. Traditionally, educators have only had access to courses and content (e.g., lectures, outlines, exams) available in print or to those generated or maintained by them or their peers at the same institution. There has been, however, a movement towards electronic sharing of courses and content within and between institutions. However, existing content management systems often require time intensive content version control and purging of redundant content.

Previous systems typically stored content either on CDs or DVDs, or on an individual instructor's hard drive and provided for content duplication only on an individual course or content item basis. Previous systems do not distinguish between student-loaded content and instructor-loaded content in copying student information into new terms, thereby potentially violating student privacy laws such as FERPA.

As such, a need exists for a content duplication and management system to address these and other shortcomings of the prior art. For example, there is a need for a central course content archival and duplication system providing increased privacy controls and batch processing capabilities.

### SUMMARY OF INVENTION

The invention facilitates electronic duplication and management of educational courses and content. The system enables users (e.g., administrators and educators) to access courses and content originating within their own institution or from any number of other institutions. Any individual course, content item, course unit, syllabus, exam, or the like may be selected for copying or duplication. Additionally, users may choose the desired arrangement or order of content at various stages of the duplication process. The invention provides a duplication request queue, duplication status and progress monitoring and reporting features, along with error and persistence messaging. The system provides varying levels of access based on a system subscription, administrative authorization, author or editor classification and the like.

In exemplary embodiments, users may duplicate one course at a time, a series of courses together or one course into multiple courses at a time. Users may also duplicate multiple courses from multiple semesters into one destination semester. Various content items such as MS Office documents or multimedia files may be copied or may be merely associated with the duplicated course or content by a pointer or link. The system copies and/or updates Text/HTML content, multimedia links, webliography content, threaded discussion introductory text and topics, and threaded discussion attachments, then updates all links to the file manager, course tool or content items. Any information, settings, documents, groups, or the like, associated with any source course or content may also be duplicated at the option of the user or by system default. Exemplary associated information includes course numbers, prerequisites, requirements, announcements, alerts, review/exam schedules, student exam reporting formats, exam styles, exam limitations (e.g., time, retakes), and the like. Such information may be duplicated along with or separate from courses or content. Version and roll-back controls as well as pointers to shared or linked documents limit or prevent redundant content.

### BRIEF DESCRIPTION OF THE DRAWINGS

Additional aspects of the invention will become evident upon reviewing the non-limiting embodiments described in the specification and the claims taken in conjunction with the accompanying figures, wherein like reference numerals denote like elements, and

FIG. 1 is a block diagram illustrating an exemplary system configured to facilitate electronic duplication of educational courses and course content according to one embodiment of the invention; and

FIG. 2 is a flowchart illustrating an exemplary duplication process according to one embodiment of the invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The invention provides systems and methods for duplicating and managing educational content, such as, for example, course content, course shell content, content items and compilations or combinations of the same. The course, course shell, and content item duplication systems may be separate or integrated and are frequently referred to herein collectively as the system. The course duplicator is used to duplicate, for example, an entire course and the content item duplicator is used to duplicate, for example, single or multiple pieces of content in a course. Users may thus duplicate individual pieces or compilations of content or entire courses including all content associated with the course, internal to an individual institution or between institutions.

Content may be learning content (e.g., a lecture or outline), assessment content (e.g., an exam question or quiz), evaluation content (e.g., student feedback information) or other relevant content. Content may be instructor loaded such as assignments or exams, or student loaded such as threaded discussions or exam answers. Administrative course settings may also be associated with course content. The term “course” includes all or any subset of content associated with a particular topic, learning objective, or curriculum. Courses may span multiple terms or semesters and may include progressions through prerequisites, course units or sub courses. A course shell is any information in addition to merely the course code or identifier such as, for example, a selected group of content, the format of the content, the order of the topics and the like. Content items are individual documents or information within a course. A course unit is a grouping or compilation of content items within a course. A course code is an internal system code assigned at creation of a course. A display course code is a code associated with a course that is displayed on user interface pages and in course catalogs. Course codes may also be associated with course folders and pre-existing approved course identifiers.

Users may duplicate one course, a series of courses, one course into multiple courses, or multiple courses from multiple semesters into one destination semester. Users may specify priority levels for courses and content to be duplicated, while bypassing of lower priority queued duplication requests. A duplication request queue allows users to move, add, or delete duplication requests within a queue. Users may select multiple courses or a block of related courses to queue up for duplication at one time. Courses may be related by term, semester, title, course code, program or campus organizational area, topic, author, prerequisites, designation (e.g., required or elective courses), optional settings (e.g., announcements), and/or any other relevant criterion or identifier. A user may copy any existing course files and folders or may create new course folders and subfolders. An exemplary course file is the syllabus outlining the course description, course objectives, required text, general policies, grading policies, custom items, and the like.

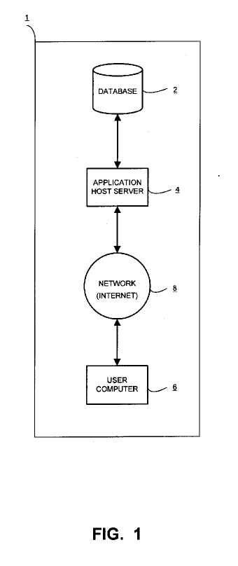

Turning to the drawings, FIG. 1 illustrates an exemplary course content duplication system 1 including a database 2, host server 4, and a user computer 6 communicating with host server 4 over a network 8. In this embodiment, host server 4 includes a web-based course content duplication software application accessible by any user computer 6 with access to Internet network 8. Alternatively, the application may be locally hosted (client managed) so that database 2 and host server 4 are accessible only over a closed network 8 at an educational institution. Courses, content, duplication applications and/or system tools may be hosted on multiple servers 4 for load balancing. Cross database duplication is contemplated, for example, in the case that content is split between two databases 4. User computer 6 may include any computer with network or Internet connectivity and a web browser.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Database 2 or other databases used herein may include: course data; content data; institution data; and/or like data useful in the operation of the present invention. As those skilled in the art will appreciate, user computer 6 may include an operating system (e.g., Windows NT, 95/98/2000, OS2, UNIX, Linux, Solaris, MacOS, etc.) as well as various conventional support software and drivers typically associated with computers. User computer 6 may include any suitable personal computer, network computer, workstation, minicomputer, mainframe or the like. User computer 6 can be in a home or educational institution environment with access to network 8. In an exemplary embodiment, access through network 8 is through the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (personal digital assistant (e.g., Palm Pilot®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. The invention may be implemented with TCP/IP communications protocols or with IPX, Appletalk, IP-6, NetBIOS, OSI or any number of existing or future protocols. If network 8 is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to network 8 via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that network 8 may be implemented as other types of networks, such as an interactive television (ITV) network. Moreover, the system contemplates the use, access, viewing, copying, sale or distribution of any information, goods or services over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The invention contemplates uses in association with web services, utility computing, pervasive and individualized computing, security and identity solutions, autonomic computing, commodity computing, mobility and wireless solutions, open source, biometrics, grid computing and/or mesh computing.

Database 2 or any other databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions database 2 according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets. Furthermore, the security information may restrict/permit only certain actions such as accessing, copying, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

User computer 6 may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying system components to further enhance security.

A firewall may include any hardware and/or software suitably configured to protect system components and/or enterprise computing resources from users of other networks. Further, a firewall may be configured to limit or restrict access to various systems and components behind the firewall for web clients connecting through a web server. The firewall may reside in varying configurations including Stateful Inspection, Proxy based and Packet Filtering among others. The firewall may be integrated within a web server or any other system components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “user”, “administrator”, “educator”, “institution”, “participant”, “client” or “campus” may be used interchangeably with each other, and each shall mean any person, entity, machine, hardware, software or business. Each user or participant is equipped with a computing device in order to interact with the system and facilitate online access and duplication of courses and content. Exemplary user computers 6 include personal computers, laptops, notebooks, hand held computers, set-top boxes, cellular telephones, and the like. Applications may be hosted at a computing center such as a main frame computer. The computing center may be implemented in other forms, such as a mini-computer, a PC server, a network of computers located in the same of different geographic locations, or the like. Moreover, the system contemplates the use, sale or distribution of any goods, services or information over any network having similar functionality described herein

In an exemplary embodiment, content duplication system 1 is implemented as computer software modules loaded onto a client computer and a host computing center. Alternatively, the client computer may not require any additional software to support use of the content duplication system. As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

In one embodiment, system 1 includes various access points or various user interfaces such as administrator, instructor, or other user web-pages. Content may be indexed or displayed on a course home content page. In an exemplary embodiment of the invention, the system interface displays a series of semester dropdown menus with courses arranged under each semester. The user interface displays course identifiers (e.g., course code or display course code) for available courses. Separate user interfaces may be provided for course duplication, course shell duplication, and content item duplication through the same access point or user interface page. Varying levels of access may be granted a user based on a subscription, administrative authorization, author or editor classification and the like. For example, educators within a given institution or campus may be granted access only to courses or content offered within a particular institution, campus, program, department. Alternatively, system administrators may facilitate cross-campus viewing or duplication of courses or content by institution administrators and educators. For example, professors at separate universities may elect to collaborate on a course or share course information by granting open or user specific access to materials.

System user interfaces may include any conventional web browser application features and menu functions. Any number of features represented by different tabs, list item, links and the like, may be accessible from any number of interactive screens. Comments fields and standard menu or action links may likewise be cross-linked or associated with any displayed information, field, or other links. Entry of information in any of the described fields may be accompanied by a summary or confirmation page. In a web-based application embodiment, the system includes conventional browser and file menu options such as, for example, find, browse, edit, format and view functions. Auto-completion may be enabled for certain fields and defaults for others may be preset or user defined. For example, the source course title may be automatically added to the destination course title field, yet still provide for alteration by a user.

Tabs, icons, list items, menu items, radio buttons, etc., may appear on more than one screen, may be used interchangeably and may be fully customizable, for example, as to number, title, contents, cross-references, appearance, order, authorization and the like. Menu and pull-down lists may contain editing options such as “Edit this Item” or “Add new Course.” Screens, windows, and dialogue boxes may refresh upon completion of certain tasks, upon depressing a mouse button or enter key, or may simply refresh at preset time intervals. Any window, screen, or document may be exported, printed, emailed, or saved. Passwords may be required for access at any given system level or feature providing increased security or privacy. Encryption may also be used to increase security.

Courses may be listed in a drop-down or pull-down menu or as individual selectable tabs or icons. Selection of a course returns a list or visualization of all content, settings, and information associated with the course. Any screen may provide links to any number of other interactive screens through a series of tabs, icons, links, menu, pull-down menus, and the like. Help dialog boxes may be displayed by positioning the mouse over or by selecting a help icon or by clicking help in the menu bar.

Searches for courses or content may be conducted with full or partial field entries, such as the first three letters of a course name or course code. Additional search options or searchable categories are provided including fields for title, program, term, semester, or other unique identifier. Advanced search options or searchable categories may be provided under an “Advanced Search” option including fields for author, publisher, comment, creation date, topic, or other searchable types of information used in the art.

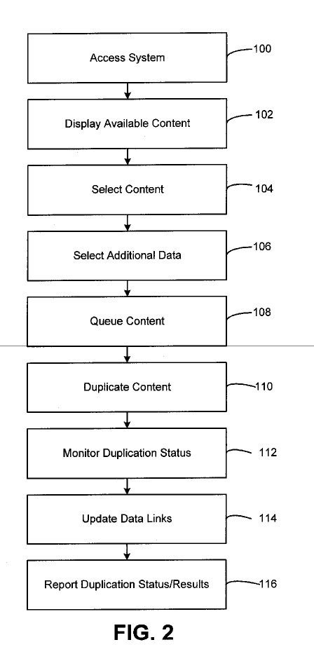

Returning to the figures, FIG. 2 illustrates an exemplary method according to one embodiment of the invention. In general, a user first accesses the system (step 100) by logging in at a secure system web-page. The system verifies entered user login information and displays the content available for duplication (step 102). The user then selects content for duplication (step 104). The user may then select additional information for duplication (step 106), such as links, settings, and the like associated with the previously selected content. Selected content is placed in a duplication queue (step 108), where the user may then prioritize duplication requests. Selected content is then duplicated in priority order (step 110). The system provides monitoring of duplication progress and status for queued items (step 112). The system updates links (step 114) to source and/or duplicated content and associated files. Duplication reports are generated (step 116) automatically, on-demand, batch or any other known method to show, for example, the number and/or status of completed and/or unsuccessful duplication requests.

More particularly, a secure login page, in step 100, may require a unique user identification and password or any other secure authentication known in the art. The system may prompt users to alter their passwords from time to time to enhance security or may even suggest various examples of password progression schemes. Users may login at multiple terminals or alternatively an administrator may limit users to a single access point. Additional security may be provided by a timed logout or screen saver after a set period of inactivity. Users may logout manually by selecting a marker or icon such as the familiar X symbol found in the upper right hand corner of many applications. Any activity such as user logout, file deletion, or duplication cancellation may include confirmation screens or dialogue boxes to prevent inadvertent cancellations and the like. For example, a logout attempt may require confirmation by clicking “OK” or “Yes, logout” in a dialog box.

In displaying the content available for duplication (e.g., step 102), varying levels of access may be granted a user based on a system subscription, administrative authorization, author or editor classification and the like. Content availability is determined by relevant user roles and access to certain areas of the campus, for example, a Business College administrator may only access Business course content. Access may also be restricted or established by the content publisher. Users may be assigned roles or role types, such as, administrator, author, publisher, educator, and the like, with corresponding access levels within the system. For example, system administrators, educational administrators and other users may be assigned various create, update, read, delete, and edit authorizations. In an exemplary embodiment, administrators may add new or delete entire courses while educators may only edit and update existing courses.

Courses may be generated and provided by a publisher rather than generated by individual institutions or educators. Publisher provided courses may be identified by a publisher course code. In one embodiment, the system automatically generates a new approved course identifier for copies of publisher generated/provided courses. Alternatively, the system may require an educator or institution to establish a new approved course identifier. Maintenance of publisher course code properties during and after duplication preserves the integrity of the publisher course code system. A similar system may also be used to maintain identifiers for individual content items.

Users may select, in step 104 for example, any course, course unit, content item, associated files and any combination of the same. Individual content items, whole units or all sections of a course are selected for duplication through a series of checkboxes and dropdown menus that allow an item to be added within or at the end of the destination course unit structure. For example, users may duplicate one course, a series of courses, one course into multiple courses, or multiple courses from multiple semesters into one destination semester. Courses may by related by topic, author, prerequisites, designation as required or elective courses, optional settings—such as announcements or by any number of other course specific information. A user may copy any existing course files and folders or may create new course folders and subfolders. An exemplary course file is the syllabus outlining the course description, course objectives, required text, general policies, grading policies, custom items, and the like.

Users may select all items in a course with one action (e.g., a single checkbox), or may select individual or multiple units, content Items, and combinations of units and content items. Units and items are movable individually or as groups within the duplication queue or tree. Users may move or duplicate content from one course to many courses in one session. The system may be set to automatically copy all content, settings, and information associated or linked to a particular selection. Alternatively, the system may provide nested check boxes or progressive systems prompts for manual selection of each individual associated or linked item. For example, when the duplicator encounters a link to a content item in copying course content, the user may be prompted as to whether to copy the link, or may be instructed that the linked content item must be copied as well. Additional instructions may include information regarding how or where to change such links after the course has been duplicated.

Administrators may choose to duplicate only course shell information for registration purposes. Alternatively, users may duplicate course content into an already existing shell. Exemplary shell information includes: course code, display course code, course title, catalog description, course taxonomy, location of school (city, state), credit for course settings, display in catalog settings, credits, maximum enrollment, maximum waitlist, in-state tuition information, out of state tuition information, service levels (academic services), source course approved course identifier, ClassLive and User Tracking on/off, help tier settings, and syllabus. Any of the above listed shell duplicator information may also be included in the full course or content duplication process.

Users may copy all exam content and set-up preferences including: exam type, exam retake options (e.g., repeat exam, new exam, limited retakes), exam title, introductory text, time allowed, page titles, page instructions, time durations (e.g., one hour), and grading options along with or separate from any course, unit, or other content item. Various embodiments include a gradebook feature and gradebook setup feature for displaying gradable content items, gradable custom items, gradable course tools and the points possible per gradable Item. Exemplary grading options include use of auto-grading to score questions (selectively excluding short answer and essay responses), automatic display of the objective score of a finished exam to students (e.g., in a system gradebook), auto-grading quick summary of scores per question, and gradebook display options (e.g., exam grade only, exam grade and questions without correct answers, exam grade and questions with correct answers, missed questions only).

In step 106, additional information, codes and settings associated with courses and content may also be selected for duplication. For example, the duplicator may copy the course code, course title, catalog description, section details, course taxonomy, location of a school (e.g., state, city), credit information, contact hours, display in catalog field, maximum enrollment, maximum waitlist, in-state tuition codes, out of state tuition codes, ClassLive on/off and enable/unenabled preferences, unit heading, instructor title, TA title, course description, style manager settings, user tracking, help tier settings, and source course identifiers into a new duplicated course. Administrators or other users may copy course administrative settings and unit navigation bar settings in addition to general course information. In one embodiment, the invention allows users to select various academic service levels during the duplication process. The existing service levels from a source course may be the default value for a duplicated course.

Users may selectively copy any or all announcements associated with courses or content. Exemplary announcements alert students to general course information such as where to begin studying, when the instructor holds “office hours” and where to find general course information. Users may also copy any number of individual content related files or settings including: dropbox set up, chat rooms, publisher links content. Users may be prompted to select optional features offered with a particular course, such as a dropbox. Dropboxes are associated with or attached to assignments to provide an area for students to load assignments into the course for an instructor to review. These dropbox locations are copied from one course to the next in order to maintain an instructor's course organizational structure.

Administrative settings associated with the gradebook, groups, dates and the dropbox are copied from the source course into the destination course. This reduces the administrative overhead for instructors teaching repeat courses. Exemplary settings include whether an item is gradeable, the number of points associated with gradeable items, the number of student groups set up within a course, and content items and dropboxes that associated only a group.

Any group settings or group associations with a unit or content item may also be copied. Exemplary groups include enrolled students, chat rooms, doc sharing areas, and email lists. Group associated content items may include threads, text/HTML, exams and MS Office Docs. Group associations facilitate threaded discussions, group projects, interactive exams, and the like. The system may further include access tiers associated with various user or student groups.

In step 108 for example, the system automatically arranges and displays content selected for duplication into queues. System administrators can intervene in queue management and processing to prevent errors or should problems or errors arise. In one embodiment, users may specify priority levels for courses and content to be duplicated within the queue, enabling bypassing of lower priority queued duplication requests. A duplication request queue allows users to move, add, or delete duplicate requests within a queue. Users may select multiple courses to queue up for duplication at one time. For example, a block of related courses may be selected and put into the duplication queue at the same time. Queue setting may be user defined or established by default. For example, a user may set a maximum wait time for a single course to duplicate or a maximum acceptable time for a course to be in the queue or a maximum number or simultaneous duplication procedures. The system supports copying using multiple queues. For example, the duplicator may pull files from one netapp, cross the network and then relocate the files on the same netapp in a different location. Alternatively, the duplicator may simply move files from one place on a netapp to another place on the netapp without crossing the network.

Courses and content may be duplicated (e.g., step 110) in a read only, archive, full access, or similar format according to the role the user has in accessing the course. For example, an exam may be duplicated as read only by a teaching assistant, but may still allow for updating of term and exam start and finish dates. Additionally, unit dates may be set to match term access dates, exam dates to match term access dates, or exam review dates to match term access end dates. The system includes a scheduling feature whereby access to exams, reviews, or other content may be restricted by date. Unit dates may be set by default to coincide with term access dates of a destination course.

Users may overwrite an existing course, course shell content, or content item according to the user's role. Data recovery means allow for recovery of overwritten data and version roll-back capabilities. Inadvertent overwriting may be reduced by placing this option in a separate workflow screen or by issuing an action confirmation string through a popup window. The system may include a tutorial or help menu to assist users in duplication of courses or content.

In step 112 for example, a status indicator or a separate status window is provided to enable users to monitor the duplication progress or status. For example, users may view a list of their queued duplication requests with corresponding status indicators. Exemplary status indicators include: waiting, in process, complete, complete with errors, unsuccessful, and the like. Users may view all courses currently in a duplication queue, the current status of each course (e.g., waiting, in process, etc.), course size, database size, and multimedia file size. System administrators may pause or cancel any item in a duplication queue. The status indicator displays the number of courses ahead of a course within a queue as well as the source course/term name, destination course/term name, display course code, course title, duplication initiation time, time completion duplication, duplicator ID number, and the like. Users may change display course codes, section numbers or course titles and the like during the duplication process.

Various system alerts or messages are provided to system users such as, for example, dialog boxes, emails, calendar reminders, pager notifications, cell phone signals or any other notification to any device discussed herein. Exemplary system alerts may be provided based on a set maximum time allowable for a particular duplication process. Alerts may be assigned different priority levels and include persistence mechanisms (e.g., alert appears X times or every x minutes until viewed/read).

In step 114 for example, destination and/or source links are automatically updated with appropriate course ID and path information including updated links to the file manager, course tool or content item. The system may also copy and update any text/HTML content, multimedia links, webliography content, thread introductory text and topics, and thread attachments. Various content items such as MS Office documents or multimedia files (e.g., Real Media and Windows Media files) may be copied or may be associated to the duplicated course or content by a pointer in or to a central file. The system may verify and update such pointers to account for updating and overwriting of files associated with a pointer. Alternatively, the system may require that replacement documents be renamed and newly associated with pointers to prevent disruption of existing pointers.

In step 116 for example, reports are generated for successful and/or failed duplication sessions. Duplication errors can occur because of problems with the source content. Error messages provide clear resolution paths for the user to follow before resubmitting the request. Reports may include subreports on a per course basis, explanations for any failed content items, and instructions for remedying or preventing such errors. Reporting over extending periods may show, for example, all courses duplicated over a semester or a 7-day period showing the status of each dupe. Exemplary report information includes: user first and last name, type of duplication (course vs. content item), duplicator ID number, source course/term name, destination course/term name, display course code, course title, duplication initiation time, duplication completion time, and duplication process status. Reports may be archived and then discarded after a set period. Reports may be automatically sent to the requesting user as well as to maintenance, helpdesk, development, and/or IT personnel. An administrator page provides reporting features including inter and/or intra-campus access to reports (e.g., a reporting tab on the administrator interface).

Error messages notify a user of anything that does or may cause the duplication process to fail. Exemplary error messages include: “Could not find unique source course” from a batch file process duplication request; and “Duplicate Course” if a batch file duplication request is redundant to a previous request. Users may disable future error messages or bypass repetitive messages. Additional system tools include a clean-up utility to delete any temp files created during the duplication process. Any number of system defaults, default overrides, and option menus may be provided at any stage during the duplication process. For example, the system default may be set to copy all document sharing files entered by author, administrator or instructor role types during the duplication process.

The system may establish various enrollment defaults or users may identify or restrict courses as enrollable or not enrollable during the duplication process. For example, users may enable auto-enrollment for students and instructor role types during the duplication process. User access to courses and content may be conditioned on calendar events such as semester dates. For example, a particular course may only be available during a particular semester, or sample exams may only be available to students during a set review period. The system allows authorized users to disable or alter such restrictions during the duplication process.

Additional system features include creation of auto-enroll courses, special courses, and cross listed courses. Groups of users (students, instructors, administrators) may be automatically enrolled into “Auto Enroll” courses. For example, incoming students may be auto-enrolled as a group or as individuals in a student orientation class. Alternatively, all students that enroll in a particular course may be auto-enrolled in a lab or TA session. Users may be required to select a source course and choose or name a destination course. Units or groups of content items from a source course may be moved between units of a destination course. For example, a user may move Unit 3 of a source course and insert it before or after Unit 2 of a destination course. The user may be presented with options as to whether remaining units in the destination course are to be renumbered or whether the unit content is to be appended to the existing content for a particular unit. When renumbering units, the gradebook in the destination course automatically recognizes that the units have been reordered and renumbers all content items and custom items assigned to these units accordingly. Units and unit content may be displayed on a unit homepage allowing users to select individual content items, groups of items, or entire units for duplication. A significant capability of each of the duplicator systems is that users may duplicate units, courses, and content not only within a given institutions or campus but also between institutions and campuses.

Any number of additional data management features, now known or later developed, may be incorporated into the present system without departing from the invention as described herein. For example, the system may be set to overwrite existing files or to require creation of unique files in the event that a source file has the same name as a destination file. The system may track and report the frequency of use for particular content items. Undo and redo features allow users to clear their last action or to clear all actions from a particular duplication session.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention.

1. An educational course content management and duplication system comprising:
a database having course content stored thereon; and,
a computer in communication with said database, said computer configured to selectively duplicate at least one of a course, course content item, course content unit, and selected data associated with selected course content stored on said database.

2. The system of claim 1, wherein said computer is further configured to provide at least one of duplication status reporting, duplication error reporting, and duplication history reporting.

3. The system of claim 1, wherein said computer is further configured to arrange course content to be duplicated into queues and to provide queue prioritization selection.

4. The system of claim 1, wherein said computer is further configured to selectively duplicate at least one of multiple courses, a series of courses, a course into multiple duplicate courses, multiple courses into one course, and multiple courses into multiple courses.

5. The system of claim 4, wherein at least one of said multiple courses and said series of courses are associated by at least one of a common topic, author, semester, publisher, prerequisite, elective course designation, and required course designation.

6. The system of claim 1, wherein said computer is further configured to associate at least one of source course content, multi-media links, and course content attachments to duplicated course content using at least one of an electronic pointer and an electronic link.

7. The system of claim 6, wherein said at least one of an electronic pointer and an electronic link is automatically updated as said course content is at least one of edited, updated, and overwritten.

8. The system of claim 1, wherein said computer is further configured to provide duplication access levels corresponding to a user classification.

9. The system of claim 1, wherein said computer is further configured to duplicate at least one of automatic enrollment, group set up, and course date settings associated with course content.

10. The system of claim 1, wherein said computer is further configured to update at least one of an ordering indicia of duplicated course content and an electronic link to data associated with said duplicated course content.

11. The system of claim 1, wherein said computer is further configured to omit student loaded content during duplication of said at least one of a course, course content item, course content unit, and selected data associated with said course content stored on said database.

12. The system of claim 1, wherein said computer is further configured to duplicate an administrative setting associated with said at least one of a course, course content item, course content unit, and selected data associated with said course content stored on said database.

13. The system of claim 12, wherein said administrative setting includes at least one of a designation of content as a gradeable item, a number of points associated with gradeable items, a number of student groups within a course, and a dropbox.

14. A computer-implemented method for facilitating the management and duplication of educational course content, the method comprising:
displaying indicia of course content available for duplication;
receiving input identifying a duplication request, wherein said duplication request includes at least one of a course content item, a course content unit, an entire course, and selected data associated with selected course content; and
duplicating based upon said duplicating request.

15. The method of claim 14, further comprising:
providing at least one of a duplication status indicator and a duplication process completion report.

16. The method of claim 14, wherein the step of displaying indicia of course content available for duplication includes varying said indicia as a function of a user's access classification.

17. The method of claim 14, further comprising:
arranging course content to be duplicated into queues; and providing queue prioritization.

18. The method of claim 14, further comprising:
associating at least one of source course content, multi-media links, and course content attachments to duplicated course content using at least one of an electronic pointer and an electronic link.

19. The method of claim 14, further comprising:
updating ordering indicia of duplicated course content and links to data associated with said duplicated course content.

20. A machine-readable medium having stored thereon a plurality of instructions, said plurality of instructions when executed by a processor, cause said processor to perform a method comprising the steps of:
accessing a first database having course content stored thereon;
outputting indicia of course content stored on said first database that is available for duplicating;
receiving input corresponding to selection of at least one of a course content item, course content unit, and course to be duplicated; and
outputting duplicated course content to at least one of said first database and a second database.

21. The method of claim 20, further comprising the step of arranging course content to be duplicated in a queue, said queue being ordered accordingly to priority level inputs associated with said course content.

22. The method of claim 20, wherein said step of outputting indicia of course content stored on said first database that is available for duplicating further comprises outputting varying indicia of course content based on varying user authorization levels.

23. The method of claim 20, wherein said step of outputting duplicated course content to at least one of said first database and a second database, further includes updating an electronic link between a source content file and said duplicated course content.
